(19) United States
(12) Patent Application Publication
(10) Pub. No.: US 2021/0110629 A1
(43) Pub. Date: Apr. 15, 2021

(54) APPARATUSES AND DEVICES FOR PROTECTING A VALIDATOR ASSEMBLY

(71) Applicant: Valiant Dreams, LLC, Yukon, OK (US)

(72) Inventor: Nathan Wesley Hines, Yukon, OK (US)

(21) Appl. No.: 17/070,721

(22) Filed: Oct. 14, 2020

Related U.S. Application Data
(60) Provisional application No. 62/914,648, filed on Oct. 14, 2019.

(51) Int. Cl. G07F 9/10

(52) U.S. Cl. CPC G07F 9/10

(57) ABSTRACT

Disclosed herein is an apparatus for protecting a validator assembly, in accordance with some embodiments. Accordingly, the apparatus comprises a body. Further, the validator body is disposable on the validator assembly. Further, a first panel is configured to define an interior space of the body and an opening of the body leading into the interior space. Further, the first panel is configured to extend over a portion of the validator assembly covering the portion based on receiving the portion in the interior space through the opening. Further, the second panel is pivotally coupled to the first panel. Further, the second panel is configured to extend over a tray of the validator assembly Further, the second panel is configured for transitioning between positions for covering a tray portion in a first position of the positions and not covering the tray portion in a second position of the positions.

The current application claims a priority to the U.S. Provisional Patent application Ser. No. 62/914,648 filed on Oct. 14, 2019.

### FIELD OF THE INVENTION

Generally, the present disclosure relates to the field of protective covers. More specifically, the present disclosure relates to apparatuses and devices for protecting a validator assembly.

### BACKGROUND OF THE INVENTION

The field of protective covers is technologically important to several industries, business organizations, and/or individuals. In particular, the use of protective covers is prevalent for protecting a validator assembly.

Existing apparatuses for protecting a validator assembly are deficient with regard to several aspects. For instance, current apparatuses do not attach to a portion of the validator assembly covering the validator assembly. Furthermore, current apparatuses do not deflect objects directed towards the validator assembly away from the validator assembly.

Therefore, there is a need for improved apparatuses and devices for protecting a validator assembly that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is an apparatus for protecting a validator assembly, in accordance with some embodiments. Accordingly, the apparatus may include a body. Further, the body may be disposable on the validator assembly. Further, the body may include at least one first panel and at least one second panel. Further, the at least one first panel may be configured to define an interior space of the body and an opening of the body leading into the interior space. Further, the interior space may be configurable for receiving at least one portion of the validator assembly through the opening. Further, the at least one first panel may be configured to extend over the at least one portion of the validator assembly covering the at least one portion based on the receiving. Further, the at least one second panel may be pivotally coupled to the at least one first panel using at least one coupling mechanism. Further, the at least one second panel may be configured to extend over at least one tray of the validator assembly. Further, the at least one second panel may be configured for transitioning between a plurality of positions in relation to the at least one first panel. Further, the at least one second panel covers at least one tray portion of the at least one tray of the validator assembly in at least one first position of the plurality of positions. Further, the at least one second panel does not cover the at least one tray portion in at least one second position of the plurality of positions. Further, the at least one second panel provides access to the at least one tray in the at least one second position. Further, the at least one second panel restricts access to the at least one tray in the at least one first position. Further, at least one object may be removably disposable on the at least one tray in the at least one second position. Further, the at least one object may be not removably disposable on the at least one tray in the at least one first position. Further, the validator assembly may be configurable for at least one dispensing and accepting the at least one object from the at least one tray.

Further disclosed herein is an apparatus for protecting a validator assembly, in accordance with some embodiments. Accordingly, the apparatus may include a body disposable on the validator assembly. Further, the body may include at least one first panel and at least one second panel. Further, the at least one first panel may be configured to define an interior space of the body and an opening of the body leading into the interior space. Further, the interior space may be configurable for receiving at least one portion of the validator assembly through the opening. Further, the at least one first panel may be configured to extend over the at least one portion of the validator assembly covering the at least one portion based on the receiving. Further, the at least one first panel may include a first top panel and a pair of first opposing side panels. Further, the first top panel may include a pair of first opposing side edges and a pair of first opposing end edges. Further, each first side panel of the pair of first opposing side panels may extend laterally from each first side edge of the pair of first opposing side edges defining the interior space and the opening. Further, the at least one second panel may be pivotally coupled to the at least one first panel using at least one coupling mechanism. Further, the at least one second panel may be configured to extend over at least one tray of the validator assembly. Further, the at least one second panel may be configured for transitioning between a plurality of positions in relation to the at least one first panel. Further, the at least one second panel covers at least one tray portion of the at least one tray of the validator assembly in at least one first position of the plurality of positions. Further, the at least one second panel does not cover the at least one tray portion in at least one second position of the plurality of positions. Further, the at least one second panel provides access to the at least one tray in the at least one second position. Further, the at least one second panel restricts access to the at least one tray in the at least one first position. Further, at least one object may be removably disposable on the at least one tray in the at least one second position. Further, the at least one object may be not removably disposable on the at least one tray in the at least one first position. Further, the validator assembly may be configurable for at least one dispensing and accepting the at least one object from the at least one tray.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is a left side view of an apparatus for protecting a validator assembly, in accordance with some embodiments.

FIG. 2 is a right side view of the apparatus, in accordance with some embodiments.

FIG. 3 is a front view of the apparatus, in accordance with some embodiments.

FIG. 4 is a bottom view of the apparatus, in accordance with some embodiments.

FIG. 5 is a left side view of the apparatus with the validator assembly, in accordance with some embodiments.

FIG. 6 is a right side view of the apparatus with the validator assembly, in accordance with some embodiments.

FIG. 7 is a top view of the apparatus with the validator assembly, in accordance with some embodiments.

FIG. 8 is a front view of the apparatus with the validator assembly, in accordance with some embodiments.

FIG. 9 is a rear view of the apparatus with the validator assembly, in accordance with some embodiments.

FIG. 10 is a left side view of an apparatus for protecting a validator assembly, in accordance with some embodiments

FIG. 11 is a right side view of the apparatus, in accordance with some embodiments.

FIG. 12 is a bottom view of the apparatus, in accordance with some embodiments.

FIG. 13 is a left side view of the apparatus with the validator assembly, in accordance with some embodiments.

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of apparatuses and device for protecting a validator assembly, embodiments of the present disclosure are not limited to use only in this context.

Overview:

The present disclosure describes apparatuses and devices for protecting a validator assembly. Further, an apparatus may include a validator guard. Further, the validator guard sits in a position that protects fluids or foreign objects from falling into the validator (such as the validator assembly) or bunch note feeder (such as the validator assembly). The validator guard works by fitting onto either a door or on top of the bunch note feeder and deflects liquids or foreign objects from getting inside of the bunch note feeder, the validator, or money clip (such as the at least one tray). The validator guard comprises a top that moves to allow users to remove money from the money clip or bunch note feeder that has been rejected by the validator. The bunch note feeder has multiple parts allowing it to fit snugly on top of the bunch note feeder, or fits on the door. The validator guard also sits on top of the bunch note feeder, protecting the orange cable, keeping the orange cable that connects the bunch note feeder to the validator to not get caught and broken by removing or inserting the assembly, that is caused by normal use. the validator guard has indents in the side of it to allow it to fit into screw holes, securing the validator guard in place. the validator guard is made of a clear material that allows for the users and cameras to see through it. This is an anti-theft mechanism. The validator guard also has a detent in the back, that if the fluid does go towards the rear of the unit, will deflect the fluid away from the validator to the ground. The validator guard is also set so that all fluids that spill onto it, will drip away from the money clip, the bunch note feeder, and the validator. The validator guard protects against foreign object damage by deflecting the objects away from the money clip, which acts as a directional scoop, funneling the foreign objects into the bunch note feeder. If these objects are not deflected away, this can allow small objects can fall into the money clip and the bunch note feeder, damaging the rollers or causing a jam condition. The validator guard also contains elements to bring the light indicators to the front of the validator, allowing users to see the light indicators that are on the front of the validator under the top side of the validator guard, allowing easier notification of validator condition to the user.

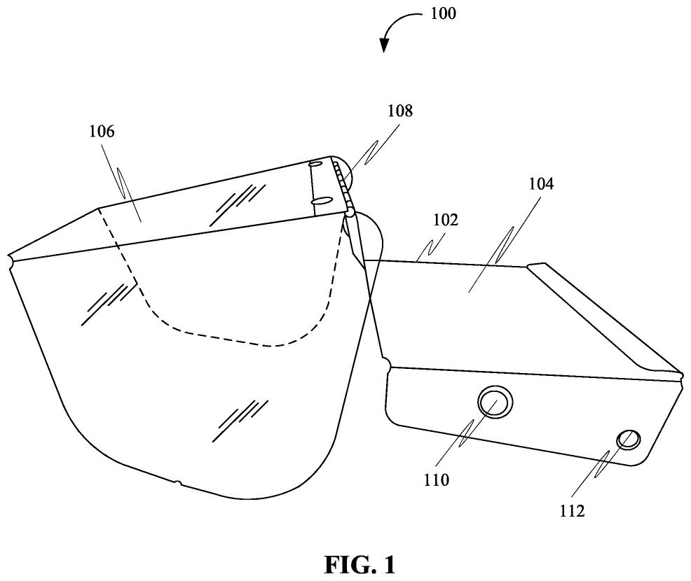

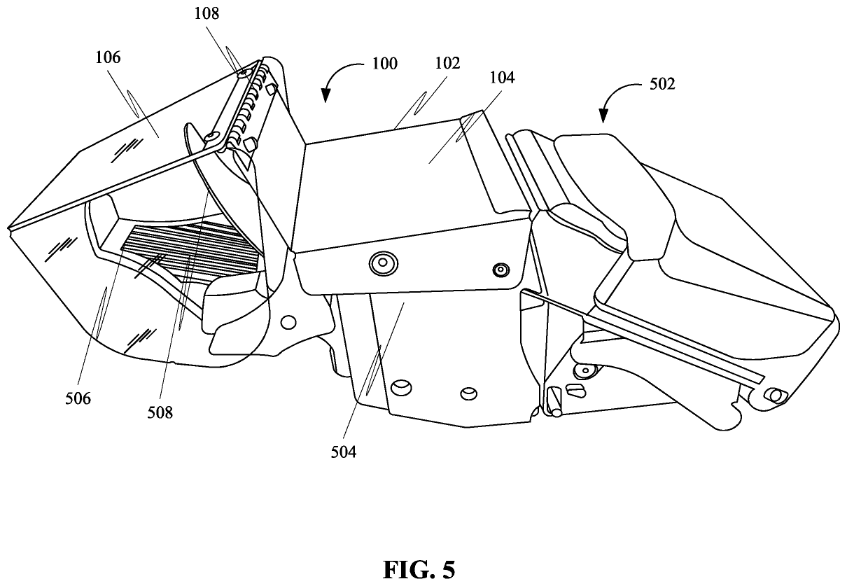

FIG. 1 is a left side view of an apparatus 100 for protecting a validator assembly 502 (as shown in FIG. 5), in accordance with some embodiments. Further, the apparatus 100 may include a body 102. Further, the body 102 may be disposable on the validator assembly 502. Further, the body 102 may include at least one first panel 104 and at least one second panel 106.

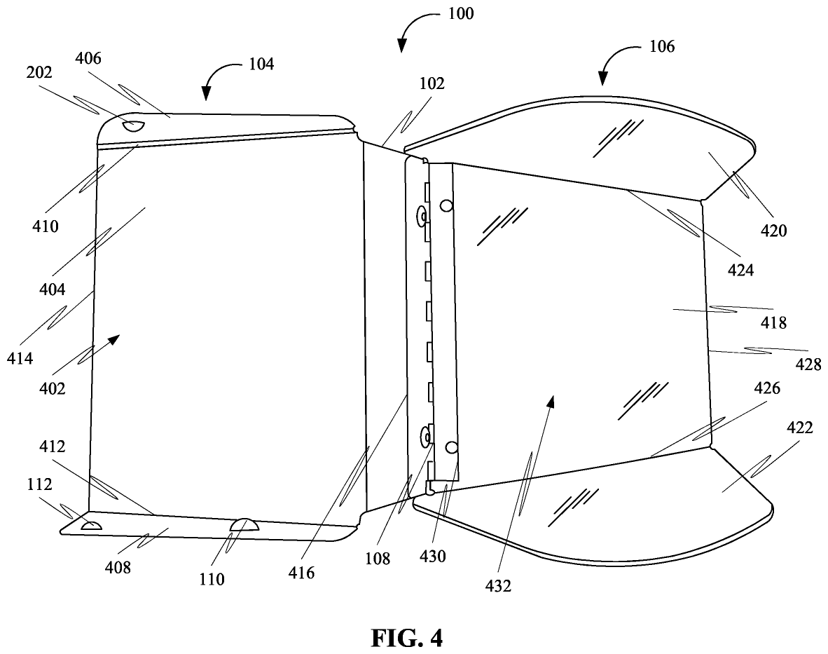

Further, the at least one first panel 104 may be configured to define an interior space 402, as shown in FIG. 4, of the body 102 and an opening of the body 102 leading into the interior space 402 Further, the interior space 402 may be configurable for receiving at least one portion 504, as shown in FIG. 5, of the validator assembly 502 through the opening. Further, the at least one first panel 104 may be configured to extend over the at least one portion 504 of the validator assembly 502 covering the at least one portion 504 based on the receiving. Further, the at least one first panel 104 may be configured for protecting the at least one portion 504 of the validator assembly 502 based on the covering.

Further, the at least one second panel 106 may be pivotally coupled to the at least one first panel 104 using at least one coupling mechanism 108. Further, the at least one second panel 106 may be configured to extend over at least one tray 506-508, as shown in FIG. 5, of the validator assembly 502. Further, the at least one coupling mechanism 108 may include at least one hinge. Additionally, the at least one coupling mechanism 108 may include two pivot points that are connected in between the first panel 104 and the second panel 106. Further, the at least one second panel 106 may be configured for transitioning between a plurality of positions in relation to the at least one first panel 104. Further, the at least one second panel 106 covers at least one tray portion of the at least one tray 506-508 of the validator assembly 502 in at least one first position of the plurality of positions. Further, the at least one second panel 106 does not cover the at least one tray portion in at least one second position of the plurality of positions. Further, the at least one second panel 106 provides access to the at least one tray 506-508 in the at least one second position. Further, the at least one second panel 106 restricts access to the at least one tray 506-508 in the at least one first position. Further, at least one object may be removably disposable on the at least one tray 506-508 in the at least one second position. Further, the at least one object may include at least one currency note, at least one bill, etc. Further, the at least one object be not removably disposable on the at least one tray 506-508 in the at least one first position. Further, the validator assembly 502 may be configurable for at least one dispensing and accepting the at least one object from the at least one tray 506-508.

Further, in some embodiments, the at least one first panel 104 may include a first top panel 404, as shown in FIG. 4, and a pair of first opposing side panels 406-408, as shown in FIG. 4. Further, the first top panel 404 may include a pair of first opposing side edges 410-412, as shown in FIG. 4, and a pair of first opposing end edges 414-416, as shown in FIG. 4. Further, each first side panel of the pair of first opposing side panels 406-408 may extend laterally from each first side edge of the pair of first opposing side edges 410-412 defining the interior space 402 and the opening.

Further, in an embodiment, the at least one second panel 106 may include a pair of second opposing end edges and a pair of second opposing side edges. Further, a primary second end edge of the pair of second opposing end edges may be pivotally coupled with a primary first opposing end edge of the pair of first opposing end edges using the at least one coupling mechanism 108. Further, in an embodiment, the at least one second panel 106 may be configured for deflecting at least one first object disposable on at least one second outer surface of the at least one second panel 106 away from the at least one tray 506-508. Further, the at least one first object may include at least one foreign object, at least one liquid, etc. Further, the at least one foreign object may include a coin, a clip, etc. Further, the at least one second outer surface may include a convex portion extending between the pair of second opposing side edges. Further, the convex portion directs the at least one first object towards at least one second side edge of the pair of second opposing side edges for deflecting the at least one first object. Further, in an embodiment, the at least one second panel 106 may be configured for deflecting at least one first object disposable on at least one second outer surface of the at least one second panel 106 away from the at least one tray 506-508. Further, the at least one second panel 106 slopes downwardly from the primary second end edge to a secondary second end edge of the pair of second opposing end edges in the at least one first position. Further, the at least one second outer surface of the at least one second panel 106 directs the at least one first object towards at least one of the secondary second end edge and at least one second side edge of the pair of second opposing side edges for deflecting the at least one first object.

Further, in an embodiment, the at least one first panel 104 may be configured for deflecting at least one first object disposable on at least one first outer surface of the top panel away from the at least one portion 504 of the validator assembly 502. Further, the at least one first outer surface may include a convex portion extending between the pair of first opposing side edges. Further, the convex portion directs the at least one first object towards at least one first side edge of the pair of opposing first side edges for deflecting the at least one first object.

Further, in some embodiments, the at least one second panel 106 may include a second top panel 418, as shown in FIG. 4, and a pair of second opposing side panels 420-422, as shown in FIG. 4. Further, the second top panel 418 may include a pair of second opposing side edges 424-426, as shown in FIG. 4, and a pair of second opposing end edges 428-430, as shown in FIG. 4. Further, each second side panel of the pair of second opposing side panels 420-422 may extend laterally from each second side edge of the pair of second opposing side edges 424-426 defining an enclosure 432, as shown in FIG. 4. Further, the enclosure 432 encloses the at least one tray portion of the at least one tray 506-508 in the at least one first position. Further, the enclosure 432 does not enclose the at least one tray portion of the at least one tray 506-508 in the at least one second position.

Further, in some embodiments, the at least one second panel 106 may include at least one transparent panel portion. Further, the at least one transparent panel portion may include at least one transparent material. Further, the at least one transparent material may include glass, plastic, etc. Further, the at least one tray portion of the at least one tray 506-508 may be visible through the at least one transparent panel portion.

Further, in some embodiments, the at least one first panel 104 may include at least one first fastening element (110-112 and 202) comprised in at least one panel portion of the at least one first panel 104. Further, the at least one first fastening element (110-112 and 202) may be configurable for interacting with at least one second fastening element comprised in the at least one portion 504. Further, the at least one first fastening element (110-112 and 202) may be configured to be fastened to the at least one second fastening element for attaching the at least one first panel 104 to the at least one portion 504 of the validator assembly 502.

Further, in an embodiment, the at least one first fastening element (110-112 and 202) may be configured to be detachably fastened to the at least one second fastening element for detachably attaching the at least one first panel 104 to the at least one portion 504 of the validator assembly 502.

Further, in an embodiment, the at least one first fastening element (110-112 and 202) may be configured to be fixedly fastened to the at least one second fastening element for fixedly attaching the at least one first panel 104 to the at least one portion 504 of the validator assembly 502.

Further, in an embodiment, the at least one first fastening element (110-112 and 202) may include at least one protrusion. Further, the at least one second fastening element may include at least one cavity. Further, the at least one cavity may include at least one screw hole disposed on the at least one portion 504. Further, the at least one protrusion may be configured to be inserted in the at least one cavity for attaching the at least one first panel 104 to the at least one portion 504 of the validator assembly 502.

Further, in some embodiments, the at least one second panel 106 may be configured for transitioning between the plurality of positions in relation to the at least one first panel 104 based on at least one action receivable by the at least one second panel 106.

Further, in some embodiments, at least one of the at least one first panel 104 and the at least one second panel 106 may include at least one element (not shown). Further, a first portion of the at least one element may be couplable with at least one indicator of the validator assembly 502. Further, the at least one element may be configured for presenting at least one signal receivable by the first portion from the at least one indicator to a second portion of the at least one element. Further, in an embodiment, the at least one element may include at least one optical element. Further, the first portion may be optically couplable with at least one visual indicator of the at least one indicator. Further, the second portion may be comprised in at least one outer surface of at least one of the at least one first panel 104 and the at least one second panel 106. Further, the at least one optical element may be configured for presenting at least one visual signal of the at least one signal receivable by the first portion from the at least one visual indicator to the at least one outer surface.

Further, in some embodiments, the body 102 may be removably disposable on the validator assembly 502.

Further, in some embodiments, the body 102 may be fixedly disposable on the validator assembly 502.

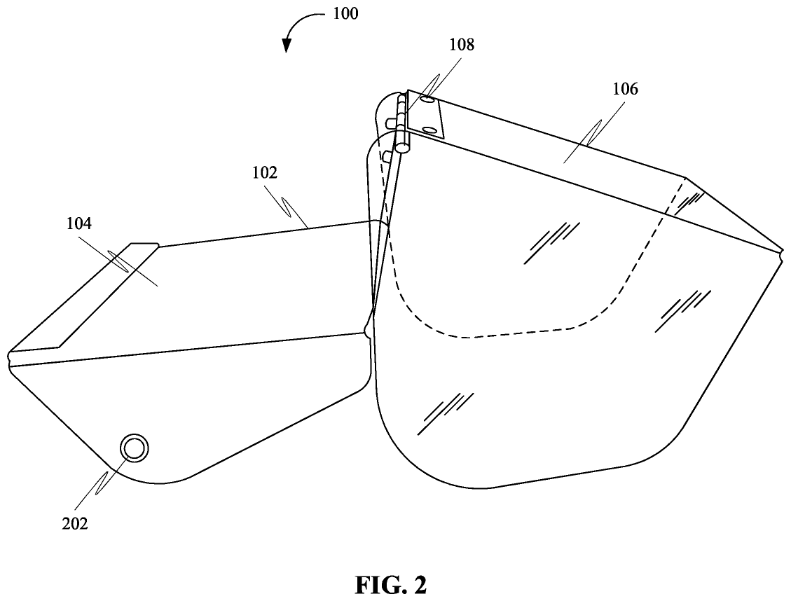

FIG. 2 is a right side view of the apparatus 100, in accordance with some embodiments.

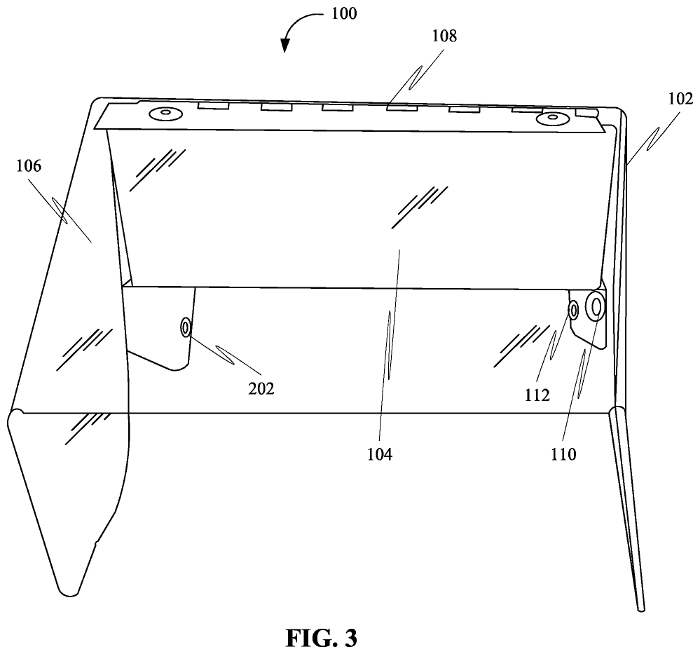

FIG. 3 is a front view of the apparatus 100, in accordance with some embodiments.

FIG. 4 is a bottom view of the apparatus 100, in accordance with some embodiments.

FIG. 5 is a left side view of the apparatus 100 with the validator assembly 502, in accordance with some embodiments. Further, the at least one second panel 106 may be in the at least one first position. Further, the at least one second panel 106 covers the at least one tray 506-508 in the at least one first position.

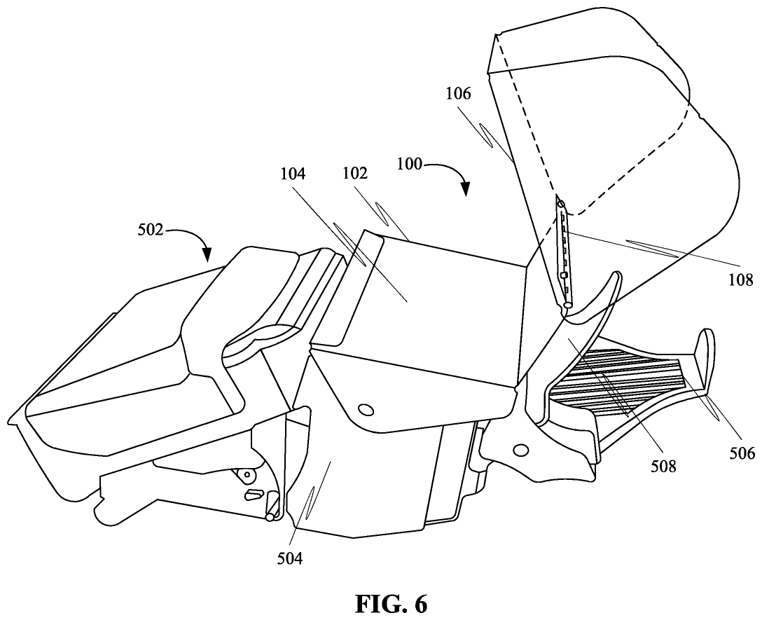

FIG. 6 is a right side view of the apparatus 100 with the validator assembly 502, in accordance with some embodiments. Further, the at least one second panel 106 may be in the at least one second position. Further, the at least one second panel 106 does not cover the at least one tray 506-508 in the at least one second position.

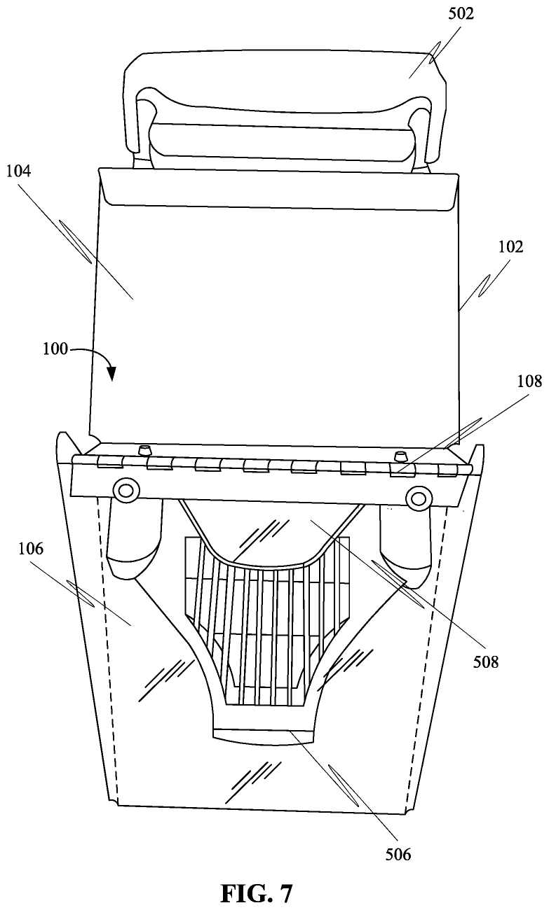

FIG. 7 is a top view of the apparatus 100 with the validator assembly 502, in accordance with some embodiments.

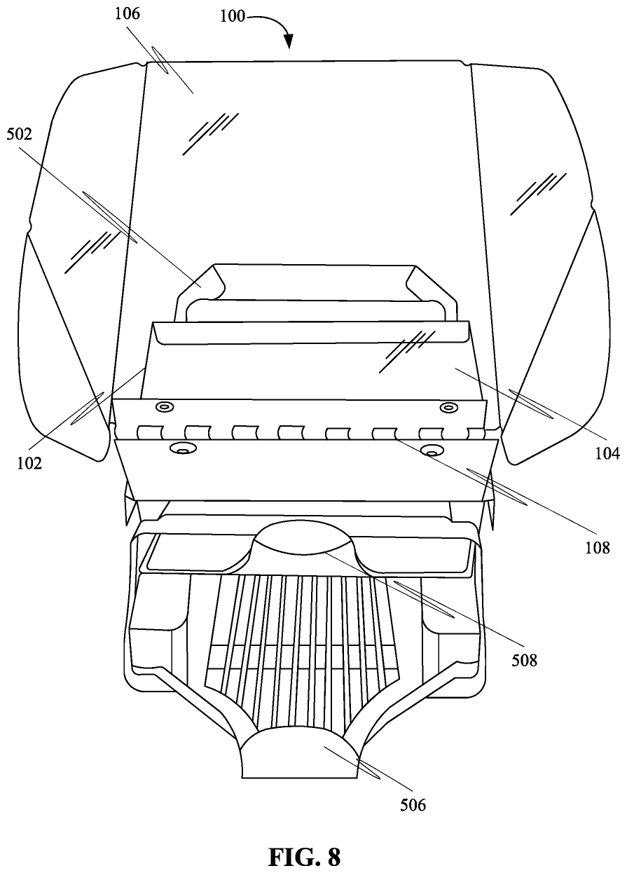

FIG. 8 is a front view of the apparatus 100 with the validator assembly 502, in accordance with some embodiments.

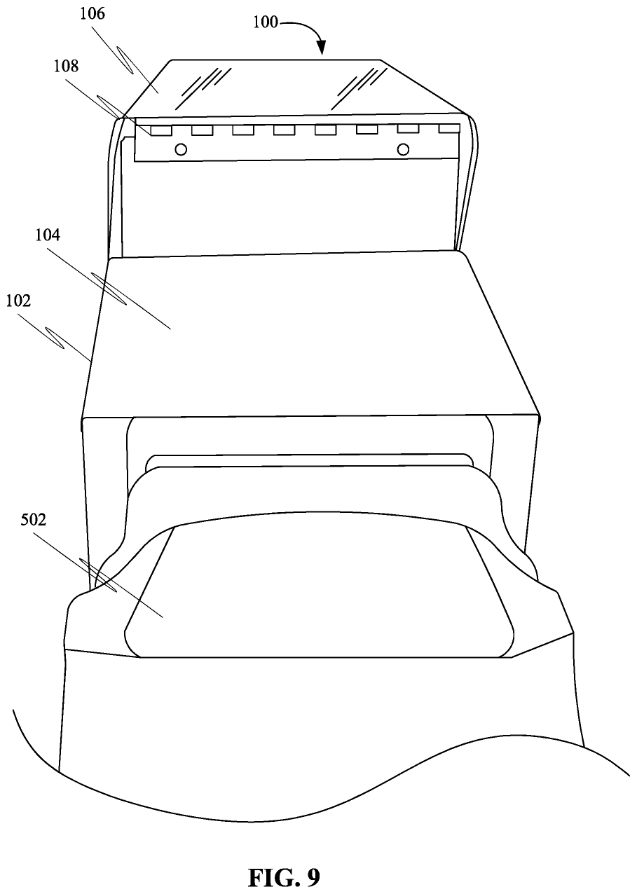

FIG. 9 is a rear view of the apparatus 100 with the validator assembly 502, in accordance with some embodiments.

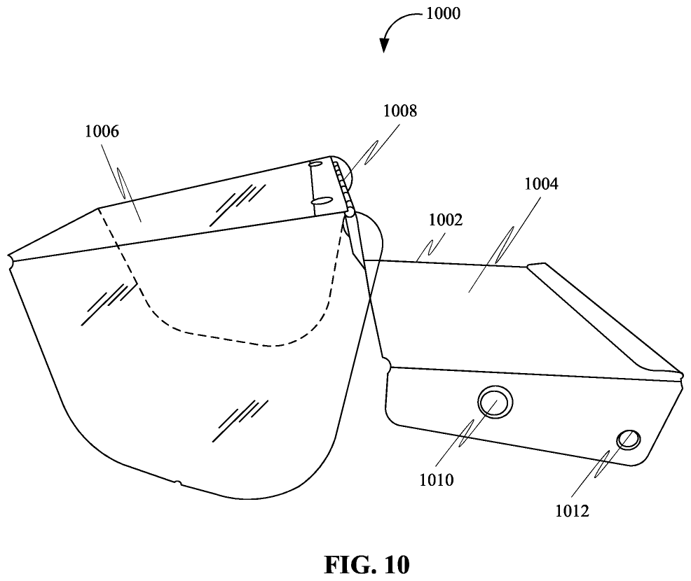

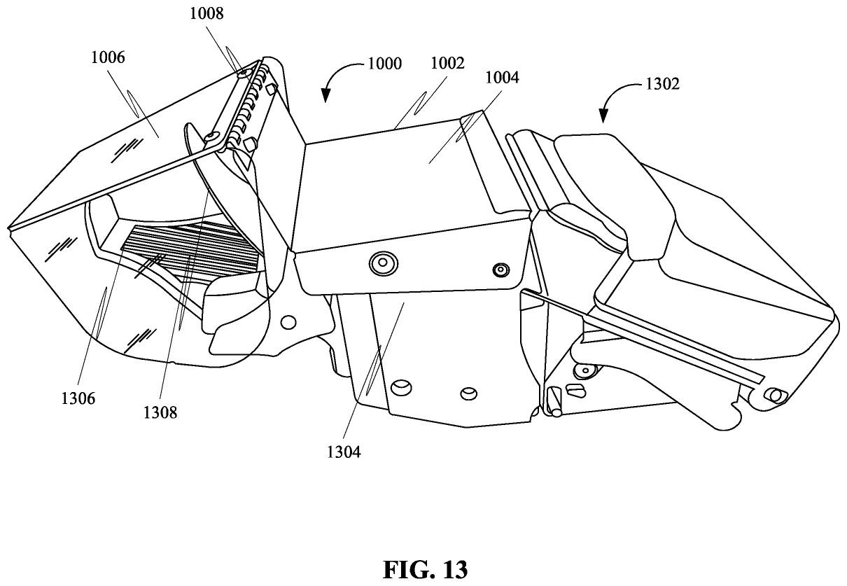

FIG. 10 is a left side view of an apparatus 1000 for protecting a validator assembly 1302 (as shown in FIG. 13), in accordance with some embodiments. Further, the apparatus 1000 may include a body 1002. Further, the body 1002 may be disposable on the validator assembly 1302. Further, the body 1002 may include at least one first panel 1004 and at least one second panel 1006.

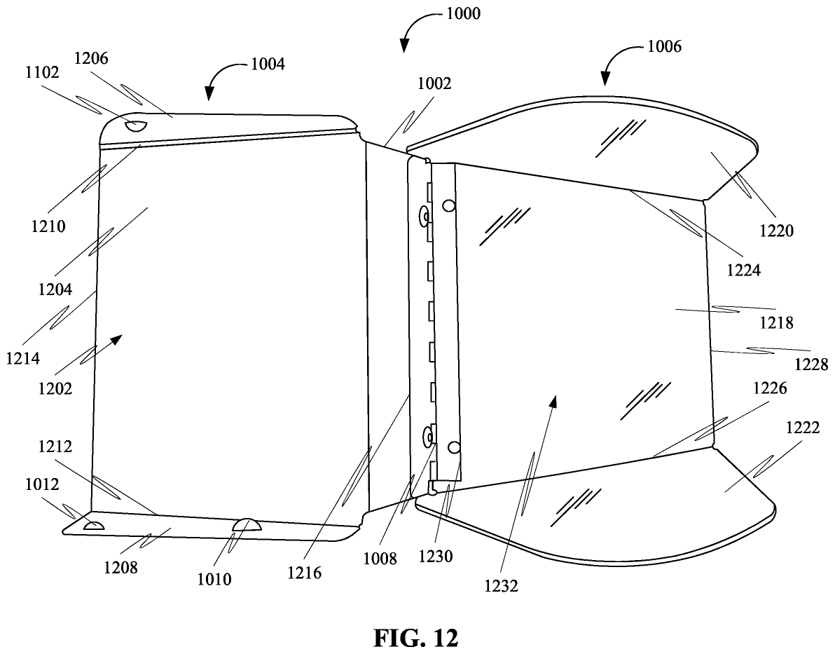

Further, the at least one first panel 1004 may be configured to define an interior space 1202, as shown in FIG. 12, of the body 1002 and an opening of the body 1002 leading into the interior space 1202 Further, the interior space 1202 may be configurable for receiving at least one portion 1304, as shown in FIG. 13, of the validator assembly 1302 through the opening. Further, the at least one first panel 1004 may be configured to extend over the at least one portion 1304 of the validator assembly 1302 covering the at least one portion 1304 based on the receiving. Further, the at least one first panel 1004 may include a first top panel 1204, as shown in FIG. 12, and a pair of first opposing side panels 1206-1208, as shown in FIG. 12. Further, the first top panel 1204 may include a pair of first opposing side edges 1210-1212, as shown in FIG. 12, and a pair of first opposing end edges 1214-1216, as shown in FIG. 12. Further, each first side panel of the pair of first opposing side panels 1206-1208 may extend laterally from each first side edge of the pair of first opposing side edges 1210-1212 defining the interior space 1202 and the opening. Further, the at least one first panel 1004 may be configured for protecting the at least one portion 1304 of the validator assembly 1302 based on the covering.

Further, the at least one second panel 1006 may be pivotally coupled to the at least one first panel 1004 using at least one coupling mechanism 1008. Further, the at least one second panel 1006 may be configured to extend over at least one tray 1306-1308, as shown in FIG. 13, of the validator assembly 1302. Further, the at least one coupling mechanism 1008 may include at least one hinge. Further, the at least one second panel 1006 may be configured for transitioning between a plurality of positions in relation to the at least one first panel 1004. Further, the at least one second panel 1006 covers at least one tray portion of the at least one tray 1306-1308 of the validator assembly 1302 in at least one first position of the plurality of positions. Further, the at least one second panel 1006 does not cover the at least one tray portion in at least one second position of the plurality of positions. Further, the at least one second panel 1006 provides access to the at least one tray 1306-1308 in the at least one second position. Further, the at least one second panel 1006 restricts access to the at least one tray 1306-1308 in the at least one first position. Further, at least one object may be removably disposable on the at least one tray 1306-1308 in the at least one second position. Further, the at least one object may include at least one currency note, at least one bill, etc. Further, the at least one object be not removably disposable on the at least one tray 1306-1308 in the at least one first position. Further, the validator assembly 1302 may be configurable for at least one dispensing and accepting the at least one object from the at least one tray 1306-1308.

Further, in some embodiments, the at least one second panel 1006 may include a second top panel 1218, as shown in FIG. 12, and a pair of second opposing side panels 1220-1222, as shown in FIG. 12. Further, the second top panel 1218 may include a pair of second opposing side edges 1224-1226, as shown in FIG. 12, and a pair of second opposing end edges 1228-1230, as shown in FIG. 12. Further, each second side panel of the pair of second opposing side panels 1220-1222 may extend laterally from each second side edge of the pair of second opposing side edges 1224-1226 defining an enclosure 1232, as shown in FIG. 12. Further, the enclosure 1232 encloses the at least one tray portion of the at least one tray 1306-1308 in the at least one first position. Further, the enclosure 1232 does not enclose the at least one tray portion of the at least one tray 1306-1308 in the at least one second position.

Further, in some embodiments, the at least one second panel 1006 may include at least one transparent panel portion. Further, the at least one transparent panel portion may include at least one transparent material. Further, the at least one transparent material may include glass, plastic, etc. Further, the at least one tray portion of the at least one tray 1306-1308 may be visible through the at least one transparent panel portion.

Further, in some embodiments, the at least one first panel 1004 may include at least one first fastening element (1010-1012 and 1102) comprised in at least one panel portion of the at least one first panel 1004. Further, the at least one first fastening element (1010-1012 and 1102) may be configurable for interacting with at least one second fastening element comprised in the at least one portion 1304. Further, the at least one first fastening element (1010-1012 and 1102) may be configured to be fastened to the at least one second fastening element for attaching the at least one first panel 1004 to the at least one portion 1304 of the validator assembly 1302.

Further, in an embodiment, the at least one first fastening element (1010-1012 and 1102) may include at least one protrusion. Further, the at least one second fastening element may include at least one cavity. Further, the at least one protrusion may be configured to be inserted in the at least one cavity for attaching the at least one first panel 1004 to the at least one portion 1304 of the validator assembly 1302.

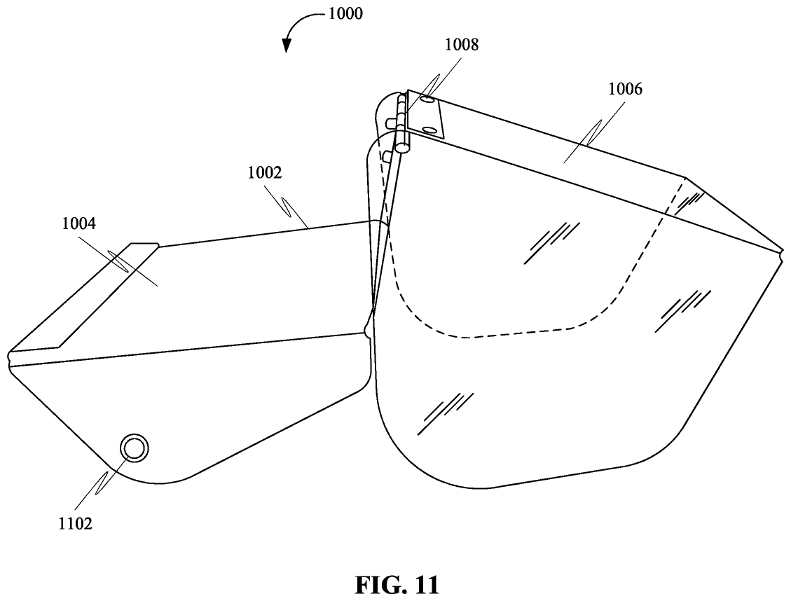

FIG. 11 is a right side view of the apparatus 1000, in accordance with some embodiments.

FIG. 12 is a bottom view of the apparatus 1000, in accordance with some embodiments.

FIG. 13 is a left side view of the apparatus 1000 with the validator assembly 1302, in accordance with some embodiments.

Although the present disclosure has been explained in relation to its preferred embodiment, it is to be understood that many other possible modifications and variations can be made without departing from the spirit and scope of the disclosure.

What is claimed is:

1. An apparatus for protecting a validator assembly, the apparatus comprising:
a body disposable on the validator assembly, wherein the body comprises:
at least one first panel configured to define an interior space of the body and an opening of the body leading into the interior space, wherein the interior space is configurable for receiving at least one portion of the validator assembly through the opening, wherein the at least one first panel is configured to extend over the at least one portion of the validator assembly covering the at least one portion based on the receiving; and
at least one second panel pivotally coupled to the at least one first panel using at least one coupling mechanism, wherein the at least one second panel is configured to extend over at least one tray of the validator assembly, wherein the at least one second panel is configured for transitioning between a plurality of positions in relation to the at least one first panel, wherein the at least one second panel covers at least one tray portion of the at least one tray in at least one first position of the plurality of positions, wherein the at least one second panel does not cover the at least one tray portion in at least one second position of the plurality of positions, wherein the at least one second panel provides access to the at least one tray in the at least one second position, wherein the at least one second panel restricts access to the at least one tray in the at least one first position, wherein at least one object is removably disposable on the at least one tray in the at least one second position, wherein the at least one object is not removably disposable on the at least one tray in the at least one first position, wherein the validator assembly is configurable for at least one dispensing and accepting the at least one object from the at least one tray.

2. The validator guard of claim 1, wherein the at least one first panel comprises a first top panel and a pair of first opposing side panels, wherein the first top panel comprises a pair of first opposing side edges and a pair of first opposing end edges, wherein each first side panel of the pair of first opposing side panels extend laterally from each first side edge of the pair of first opposing side edges defining the interior space and the opening.

3. The validator guard of claim 2, wherein the at least one second panel comprises a pair of second opposing end edges and a pair of second opposing side edges, wherein a primary second end edge of the pair of second opposing end edges is pivotally coupled with a primary first opposing end edge of the pair of first opposing end edges using the at least one coupling mechanism.

4. The validator guard of claim 3, wherein the at least one second panel is configured for deflecting at least one first object disposable on at least one second outer surface of the at least one second panel away from the at least one tray, wherein the at least one second outer surface comprises a convex portion extending between the pair of second opposing side edges, wherein the convex portion directs the at least one first object towards at least one second side edge of the pair of second opposing side edges for deflecting the at least one first object.

5. The validator guard of claim 3, wherein the at least one second panel is configured for deflecting at least one first object disposable on at least one second outer surface of the at least one second panel away from the at least one tray, wherein the at least one second panel slopes downwardly from the primary second end edge to a secondary second end edge of the pair of second opposing end edges in the at least one first position, wherein the at least one second outer surface of the at least one second panel directs the at least one first object towards at least one of the secondary second end edge and at least one second side edge of the pair of second opposing side edges for deflecting the at least one first object.

6. The validator guard of claim 2, wherein the at least one first panel is configured for deflecting at least one first object disposable on at least one first outer surface of the top panel away from the at least one portion of the validator assembly, wherein the at least one first outer surface comprises a convex portion extending between the pair of first opposing side edges, wherein the convex portion directs the at least one first object towards at least one first side edge of the pair of opposing first side edges for deflecting the at least one first object.

7. The validator guard of claim 1, wherein the at least one second panel comprises a second top panel and a pair of second opposing side panels, wherein the second top panel comprises a pair of second opposing side edges and a pair of second opposing end edges, wherein each second side panel of the pair of second opposing side panels extend laterally from each second side edge of the pair of second opposing side edges defining an enclosure, wherein the enclosure encloses the at least one tray portion of the at least one tray in the at least one first position, wherein the enclosure does not enclose the at least one tray portion of the at least one tray in the at least one second position.

8. The validator guard of claim 1, wherein the at least one second panel comprises at least one transparent panel portion, wherein the at least one transparent panel portion comprises at least one transparent material, wherein the at least one tray portion of the at least one tray is visible through the at least one transparent panel portion.

9. The validator guard of claim 1, wherein the at least one first panel comprises at least one first fastening element comprised in at least one panel portion of the at least one first panel, wherein the at least one first fastening element is configurable for interacting with at least one second fastening element comprised in the at least one portion, wherein the at least one first fastening element is configured to be fastened to the at least one second fastening element for attaching the at least one first panel to the at least one portion of the validator assembly.

10. The validator guard of claim 9, wherein the at least one first fastening element is configured to be detachably fastened to the at least one second fastening element for detachably attaching the at least one first panel to the at least one portion of the validator assembly.

11. The validator guard of claim 9, wherein the at least one first fastening element is configured to be fixedly fastened to the at least one second fastening element for fixedly attaching the at least one first panel to the at least one portion of the validator assembly.

12. The validator guard of claim 9, wherein the at least one first fastening element comprises at least one protrusion, wherein the at least one second fastening element comprises at least one cavity, wherein the at least one protrusion is configured to be inserted in the at least one cavity for attaching the at least one first panel to the at least one portion of the validator assembly.

13. The validator guard of claim 1, wherein the at least one second panel is configured for transitioning between the plurality of positions in relation to the at least one first panel based on at least one action receivable by the at least one second panel.

14. The validator guard of claim 1, wherein at least one of the at least one first panel and the at least one second panel comprises at least one element, wherein a first portion of the at least one element is couplable with at least one indicator of the validator assembly, wherein the at least one element is configured for presenting at least one signal receivable by the first portion from the at least one indicator to a second portion of the at least one element.

15. The validator guard of claim 14, wherein the at least one element comprises at least one optical element, wherein the first portion is optically couplable with at least one visual indicator of the at least one indicator, wherein the second portion is comprised in at least one outer surface of at least one of the at least one first panel and the at least one second panel, wherein the at least one optical element is configured for presenting at least one visual signal of the at least one signal receivable by the first portion from the at least one visual indicator to the at least one outer surface.

16. An apparatus for protecting a validator assembly, the apparatus comprising:
a body disposable on the validator assembly, wherein the body comprises:
at least one first panel configured to define an interior space of the body and an opening of the body leading into the interior space, wherein the interior space is configurable for receiving at least one portion of the validator assembly through the opening, wherein the at least one first panel is configured to extend over the at least one portion of the validator assembly covering the at least one portion based on the receiving, wherein the at least one first panel comprises a first top panel and a pair of first opposing side panels, wherein the first top panel comprises a pair of first opposing side edges and a pair of first opposing end edges, wherein each first side panel of the pair of first opposing side panels extend laterally from each first side edge of the pair of first opposing side edges defining the interior space and the opening; and
at least one second panel pivotally coupled to the at least one first panel using at least one coupling mechanism, wherein the at least one second panel is configured to extend over at least one tray of the validator assembly, wherein the at least one second panel is configured for transitioning between a plurality of positions in relation to the at least one first panel, wherein the at least one second panel covers at least one tray portion of the at least one tray in at least one first position of the plurality of positions, wherein the at least one second panel does not cover the at least one tray portion in at least one second position of the plurality of positions, wherein the at least one second panel provides access to the at least one tray in the at least one second position, wherein the at least one second panel restricts access to the at least one tray in the at least one first position, wherein at least one object is removably disposable on the at least one tray in the at least one second position, wherein the at least one object is not removably disposable on the at least one tray in the at least one first position, wherein the validator assembly is configurable for at least one dispensing and accepting the at least one object from the at least one tray.

17. The validator guard of claim 16, wherein the at least one second panel comprises a second top panel and a pair of second opposing side panels, wherein the second top panel comprises a pair of second opposing side edges and a pair of second opposing end edges, wherein each second side panel of the pair of second opposing side panels extend laterally from each second side edge of the pair of second opposing side edges defining an enclosure, wherein the enclosure encloses the at least one tray portion of the at least one tray in the at least one first position, wherein the enclosure does not enclose the at least one tray portion of the at least one tray in the at least one second position.

18. The validator guard of claim 16, wherein the at least one second panel comprises at least one transparent panel portion, wherein the at least one transparent panel portion comprises at least one transparent material, wherein the at least one tray portion of the at least one tray is visible through the at least one transparent panel portion.

19. The validator guard of claim 16, wherein the at least one first panel comprises at least one first fastening element comprised in at least one panel portion of the at least one first panel, wherein the at least one first fastening element is configurable for interacting with at least one second fastening element comprised in the at least one portion, wherein the at least one first fastening element is configured to be fastened to the at least one second fastening element for attaching the at least one first panel to the at least one portion of the validator assembly.

20. The validator guard of claim 19, wherein the at least one first fastening element comprises at least one protrusion, wherein the at least one second fastening element comprises at least one cavity, wherein the at least one protrusion is configured to be inserted in the at least one cavity for attaching the at least one first panel to the at least one portion of the validator assembly.
